(19) United States
(12) Patent Application Publication
(10) Pub. No.: US 2015/0226381 A1
(43) Pub. Date: Aug. 13, 2015

(54) One-Piece Circuit Board-Based LED Lamp Bulb

(71) Applicant: Tse Min Chen, Hsinchu (TW)

(72) Inventor: Tse Min Chen, Hsinchu (TW)

(21) Appl. No.: 14/176,245

(22) Filed: Feb. 10, 2014

(51) Int. Cl. F21K 99/00; F21V 23/00

(52) U.S. Cl. CPC F21K 9/1355; F21V 23/005; F21Y 2101/02

(57) ABSTRACT

A LED lamp bulb includes a lamp base, a bulb mounted at the top side of the lamp base, and a circuit board electrically connected to the lamp base and surrounded by the bulb. The circuit board is an one-piece circuit board longitudinally inserted into the inside of the lamp base and thus electrically connected with the lamp base, having one or a number of first light-emitting diodes and one or a number of second light-emitting diodes respectively mounted at respective top ends of opposing first and second sides thereof for enabling the LED lamp bulb to emit light uniformly in all directions. Thus, this one-piece circuit board-based LED lamp bulb greatly saves the installation labor and time. Further, because no any further soldering process is necessary, the invention greatly increases the yield and improves the product quality.

### BACKGROUND OF THE INVENTION

1. Field of the Invention

The present invention relates to lamps and more particularly, to a LED lamp bulb, which simply uses one single piece of circuit board, saving the installation labor and time, eliminating further soldering process, increasing the yield and greatly improving the product quality.

2. Description of the Related Art

In a conventional LED lamp bulb (see FIG. 1 and FIG. 2), in the consideration of optical factors, LEDs (light-emitting diodes) 6 must be disposed in an upward position. According to this prior art design, LEDs 6 are mounted in the top side of a first circuit board 81 that is electrically connected to a top side of a second circuit board 82 that is vertically mounted in a lamp base 7. Because related electronic components, such as bridge rectifier 91, AC step-down high voltage capacitor 92, resistor 93, LED current-limit resistor 94 require much installation space, they cannot be mounted with the LEDs 6 in the top side of the first circuit board 81. Because this prior art design needs to install one first circuit board 81 and one second circuit board 82, an additional soldering process is needed to electrically connect the first circuit board 81 to the second circuit board 82, complicating the installation and also relatively increasing the defect rate.

### SUMMARY OF THE INVENTION

The present invention has been accomplished under the circumstances in view. It is therefore the main object of the present invention to provide a LED lamp bulb, which simply uses one single piece of circuit board, saving the installation labor and time, eliminating further soldering process, increasing the yield and greatly improving the product quality.

### BRIEF DESCRIPTION OF THE DRAWING

FIG. 1 is an exploded view of a LED lamp bulb according to the prior art.

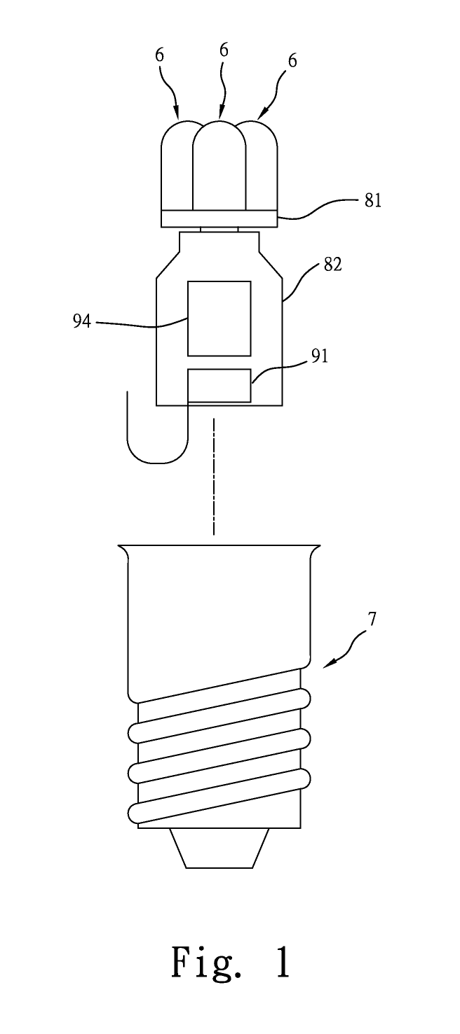

FIG. 2 is a side plain view of a part of the prior art LED lamp bulb.

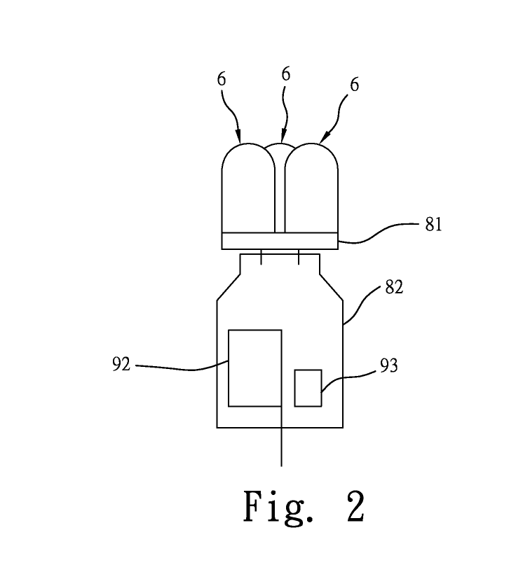

FIG. 3 is an exploded view of a LED lamp bulb in accordance with a first embodiment of the present invention (the bulb excluded).

FIG. 4 is a side plain view of the circuit board of the LED lamp bulb in accordance with the first embodiment of the present invention.

FIG. 5 is an assembly view of the circuit board and lamp base of the LED lamp bulb in accordance with the first embodiment of the present invention.

FIG. 6 is a front plain view of the LED lamp bulb in accordance with the first embodiment of the present invention.

FIG. 7 is an exploded view of a LED lamp bulb in accordance with a second embodiment of the present invention (the bulb excluded).

FIG. 8 is a side plain view of the circuit board of the LED lamp bulb in accordance with the second embodiment of the present invention.

### DETAILED DESCRIPTION OF THE INVENTION

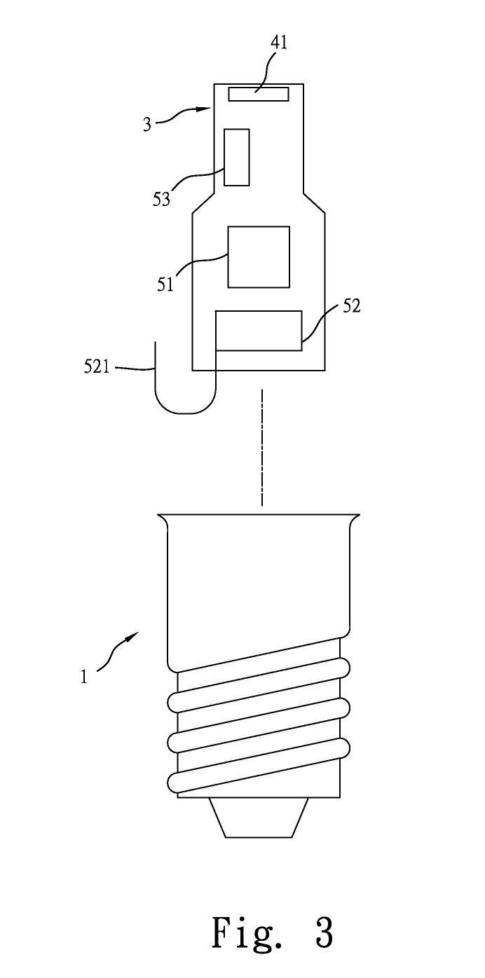

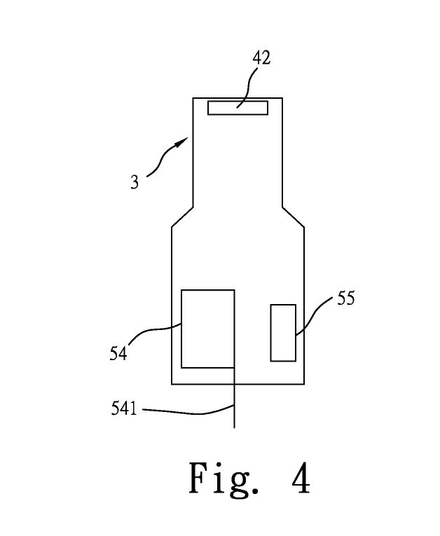

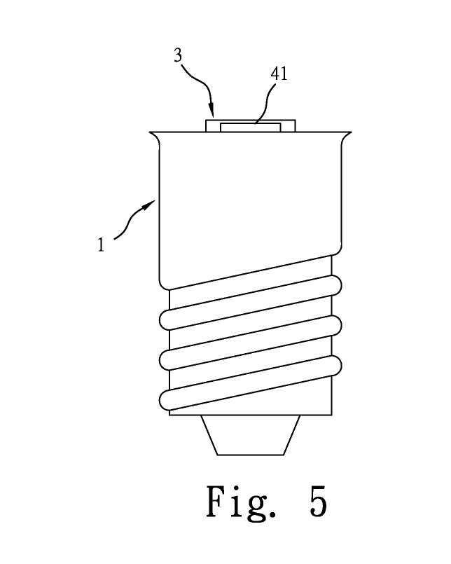

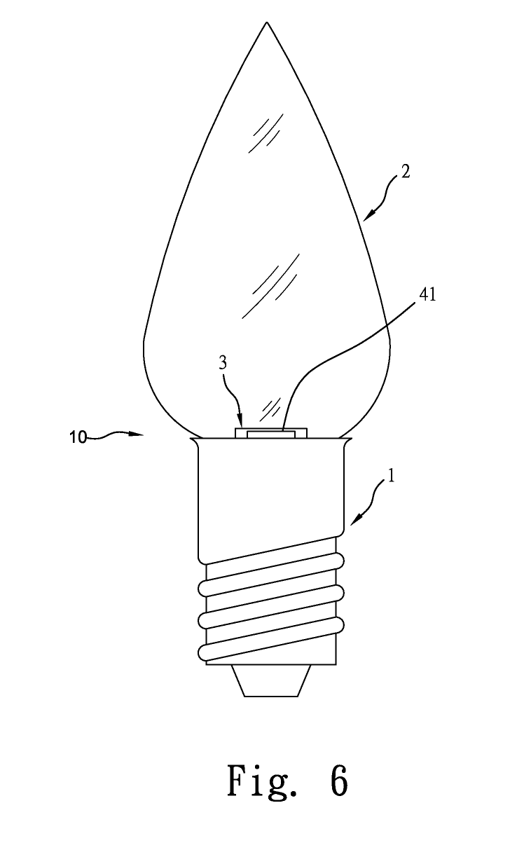

Referring to FIGS. 3-6, a LED lamp bulb 10 in accordance with a first embodiment of the present invention is shown. The LED lamp bulb 10 comprises a lamp base 1, a bulb 2 mounted at a top side of the lamp base 1 (see FIG. 6), and a circuit board 3 electrically connected to the lamp base 1 and surrounded by the bulb 2. The circuit board 3 has at least one LED (light-emitting diode) 41, a bridge rectifier 51, a first resistor 52 and a LED current-limit resistor 53 installed in a first side thereof, and at least one LED 42 (see FIG. 4), an AC step-down high voltage capacitor 54 and a second resistor 55 installed in an opposite second side thereof. The first resistor 52 has the negative terminal 521 thereof electrically connected to the lamp base 1 to form a positive contact. The AC step-down high voltage capacitor 54 has the positive terminal 541 thereof electrically connected to the lamp base 1.

The first embodiment of the present invention is characterized in that:

The circuit board 3 is a one-piece circuit board longitudinally inserted into the inside of lamp base 1 and thus electrically connected with the lamp base 1; the LED 41 and the LED 42 that are respectively disposed at respective top ends of the first side and second side of the circuit board 3 near the topmost edge of the circuit board 3 for enabling the LED lamp bulb A to emit light uniformly in all directions. Because only one single piece of circuit board 3 is used in this first embodiment, the invention greatly saves the installation labor and time. Further, because no any further soldering process is necessary, the invention greatly increases the yield and improves the product quality.

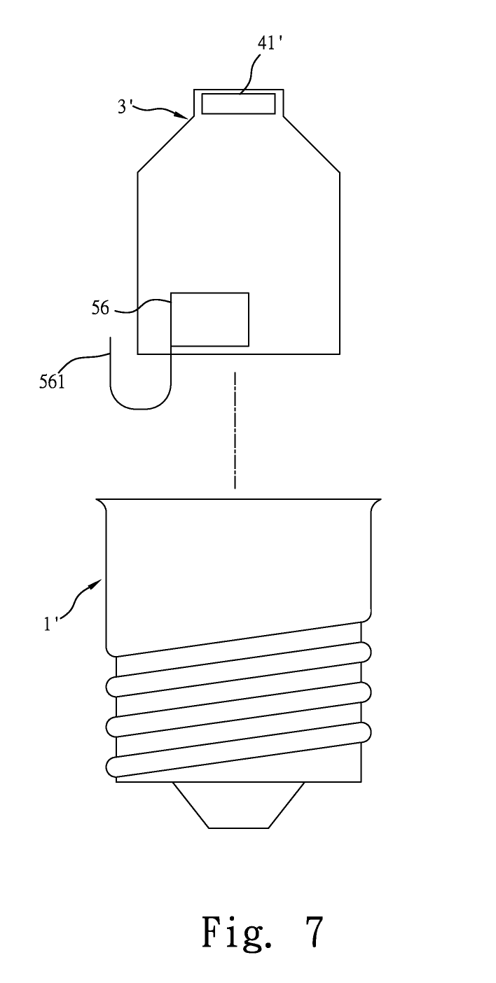

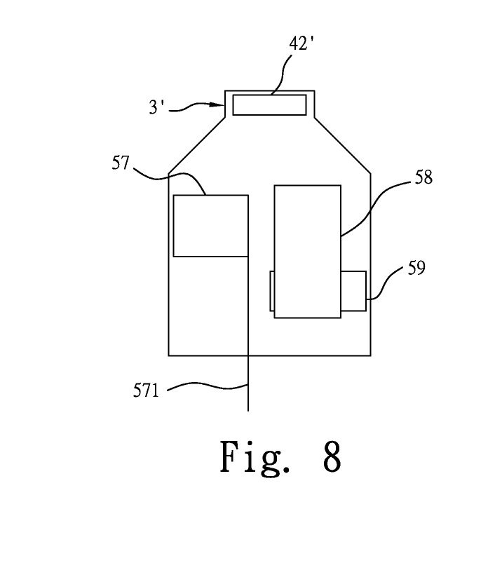

Referring to FIGS. 7 and 8, a LED lamp bulb in accordance with a second embodiment of the present invention is shown. The LED lamp bulb of this second embodiment comprises a lamp base 1′, a bulb (not shown) mounted at a top side of the lamp base 1′, and a circuit board 3′ electrically connected to the lamp base 1′ and surrounded by the bulb. The circuit board 3′ has at least one LED (light-emitting diode) 41′ and an AC step-down high voltage capacitor 56 installed in a first side thereof (see FIG. 7), and at least one LED 42′, a bridge rectifier 57, a LED current-limit resistor 59 and a LED filter capacitor 58 installed in an opposite second side thereof (see FIG. 8). The AC step-down high voltage capacitor 56 has the negative terminal 561 thereof electrically connected to the lamp base 1′ to form a positive contact. The bridge rectifier 57 has the positive terminal 571 thereof electrically connected to the lamp base 1′.

The second embodiment of the present invention is characterized in that:

The circuit board 3′ is a one-piece circuit board longitudinally inserted into the inside of lamp base 1′ and thus electrically connected with the lamp base 1′; the LED 41′ and the LED 42′ that are respectively located the opposing first and second sides of the circuit board 3′ are disposed at respective top ends of the first side and second side of the circuit board 3′ near the topmost edge of the circuit board 3′ for enabling the LED lamp bulb to emit light uniformly in all directions. Because only one single piece of circuit board 3′ is used in this second embodiment, the invention greatly saves the installation labor and time. Further, because no any further soldering process is necessary, the invention greatly increases the yield and improves the product quality.

Further, the at least one LED 41 at the first side of the circuit board 3′ or the at least one LED 42 at the second side of the circuit board 3′ can be comprised of at least one side-emitting LED, at least one front-emitting LED, or the combination of at least one side-emitting LED and at least one front-emitting LED.

What is claimed is:

1. A LED lamp bulb comprising a lamp base, a bulb mounted at a top side of said lamp base, and a circuit board electrically connected to said lamp base and surrounded by said bulb, said circuit board comprising opposing first side and second side, at least one first light-emitting diode mounted at said first side and at least one second light-emitting diode mounted at said second side, wherein:
said circuit board is an one-piece circuit board longitudinally inserted into the inside of said lamp base and thus electrically connected with said lamp base; said at least one first light-emitting diode and said second light-emitting diode are respectively located at respective top ends of said first side and said second side of said circuit board for enabling the LED lamp bulb to emit light uniformly in all directions.

2. The LED lamp bulb as claimed in claim 1, wherein said at least one first light-emitting diode at said first side of said circuit board comprises at least one side-emitting light-emitting diode and at least one front-emitting light-emitting diode.

3. The LED lamp bulb as claimed in claim 1, wherein said at least one second light-emitting diode at said second side of said circuit board comprises at least one side-emitting light-emitting diode and at least one front-emitting light-emitting diode.
